(19) United States
(12) Patent Application Publication
(10) Pub. No.: US 2003/0177815 A1
(43) Pub. Date: Sep. 25, 2003

(54) Pellet resistor sensor

(76) Inventor: Robert John White, Hants (GB)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/360,552

(22) Filed: Feb. 7, 2003

Related U.S. Application Data
(63) Continuation of application No. PCT/GB01/03545, filed on Aug. 7, 2001.

(30) Foreign Application Priority Data
Aug. 10, 2000 (GB) GB 0019649.3

(51) Int. Cl. G01N 25/00

(52) U.S. Cl. 73/31.05; 73/23.2

(57) ABSTRACT

A pellet resistor gas sensor includes a housing and sensor, the sensor being located in said housing and being adapted to provide a signal indicative of the presence of a gas in said housing. A test gas generator supplies a test gas into the housing on demand. This enables the operation of the sensor to be verified. The test gas generator preferably includes electrodes having a catalyst such as carbon, platinum, ruthenium or rhodium for promoting the generation of the test gas, and electrical contacts, in the form of pins, which connect electrodes within the housing to external wires, which lead to a remote current source. The pins may be in seating engagement with apertures in the housing through which they protrude.

### RELATED APPLICATION

This application is a continuation of earlier filed International application No. PCT/GB01/03545 filed Aug. 7, 2001. The contents of the earlier filed application are here incorporated by reference in its entirety.

### BACKGROUND OF THE INVENTION

1. Field of the Invention

The present invention relates to pellet resistor sensors. Pellet resistor sensors are sometimes referred to as pellistor sensors.

2. Prior Art

Pellistors are devices that have been used for many years to sense flammable gases and vapours. Pellistors are sometimes referred to as catalytic bead sensors. Pellistors are used in explosive environments such as mines, oilrigs and oil refineries. An alarm is triggered by the pellistor when a certain concentration threshold of gas or vapour is exceeded.

An example of a pellistor is a loop or coil of conductive wire, coated with a ceramic layer or coating. Current passes through the conductive wires. In a pellistor sensor two pellistors are arranged in a bridge configuration. One of the pellistors is coated with an active catalyst, and is known as the detector; the other pellistor has no catalyst, is therefore relatively inactive and is known as the compensator. When configured in this way, pellistor sensors may detect flammable gases at low concentrations efficiently and safely.

Gas detection occurs when gas diffuses through a gas permeable membrane into a flameproof housing in which the pellistors are housed. For each flammable gas, there is a maximum concentration in air, which, once exceeded, produces an ignitable mixture that can continue burning without a flame. This ignition may produce an explosion. This concentration is known as the lower explosion limit (LEL) and differs between organic vapours. The LEL ranges from around 15% for anhydrous ammonia to around 0.5% for kerosenes. However, even below the LEL mixtures of flammable gases may be oxidised by a suitable catalyst such as platinum or palladium.

During operation, flammable vapour or gas diffuses into the housing and comes into contact with each of the pellistors, which can typically have a surface temperature of around 400° C. When a flammable substance contacts the hot surface of the active pellistor it is oxidised in an exothermic reaction. The resultant heat generated causes heating of the active pellistor and a change in the resistance of the conductive wire. The change in resistance causes an imbalance in the bridge circuit that is proportional to the concentration of gas present. It is relatively straightforward to measure the proportion of gas present, using external circuitry. The inactive bead (or compensator) is present to minimize the environmental effects, such as temperature and humidity. As both pellistors behave similarly with temperature and humidity variation, no imbalance is seen in the bridge circuit, when no gas is present.

Pellistor technology has been used successfully in many industrial applications for more than three decades. However, pellistors are extremely susceptible to poisoning by chemicals such as sulphides and silicones; in other words the type of substances, which are frequently found in places such as coal mines and oil rigs. It is therefore essential that instrumentation using pellistors is checked regularly to ensure that the sensor is still working and has not been poisoned to below its required sensitivity.

Such calibration or testing is often difficult for two reasons: Firstly, the pellistor sensor is usually situated in difficult areas to access (behind cabling or above suspended ceilings) and hence it is awkward to apply a test gas, secondly, calibration gas cylinders can be difficult to acquire and/or use.

The problem of locating relatively inaccessible pellistors and related sensors, for example in mines, in order to test them is acute. The problem has been partially resolved by installing gas conduits, which deliver a test gas to each of several pellistor sensors so as to verify they are still operative or have not been poisoned. However, this technique of testing pellistors requires expensive installation of pipe work, which in itself entailed introduction of more potentially flammable gas. Furthermore, relocation of gas sensors, for example to different areas in a mine, is expensive and difficult, as related pipe work (to deliver test gas) has to be removed and re-installed.

### SUMMARY OF THE INVENTION

The present invention can mitigate the aforementioned, and related, problems.

According to the present invention there is provided a pellet resistor sensor, located in a sensor housing and adapted to provide a signal indicative of the presence of a gas in said housing, characterized in that a test gas generator is provided for supplying a test gas, on demand, into said housing, thereby enabling efficacy of the pellistor to be verified. Preferably the test gas generator includes an electro-chemical call capable of producing hydrogen.

In a preferred embodiment the test gas generator comprises a housing containing sulphuric acid and has a gas permeable cover. The gas permeable cover can comprise a microporous membrane which has been coated with polytetraflourethene (PTFE). In a particularly advantageous embodiment electrodes are printed onto the microporous membrane.

Electrodes may include any suitable catalyst that promotes the generation of the requisite test gas. In the aforementioned embodiment, the test gas generated is hydrogen from sulphuric acid electrolyte. It has been found that carbon or more preferably ruthenium electrodes enhance the generation of hydrogen gas from this electrode.

Electrical contacts, in the form of pins, connect electrodes (within the housing) to external wires that lead to a remote current source. The pins not only act as electric conductors, but also plug apertures in which they are located. Preferably the pins comprise a synthetic plastics material which, when heat-treated, seals the pins in the apertures, whilst also permitting an electric pathway to exist from external wiring to the electrodes.

Electric current passes through these two electrodes and acid catalyzed electrolysis of the electrolyte take places according to the following reaction equation:

2H₂0+2e→4H₂+20H

Hydrogen gas (H₂) generated diffuses through the microporous membrane and passes to a detector pellistor. Typically 2% v/v of hydrogen gas is sufficient to test the 50% LEL alarm level of the sensor in which the pellistor is fitted.

### BRIEF DESCRIPTION OF THE DRAWINGS

Embodiments of the invention will now be described, by way of examples only, with reference to the following schematic Figures; in which

FIG. 1 shows a section of a pellistor sensor showing key components;

FIG. 2 shows a section of an embodiment of the invention; and

FIG. 3 shows a section of an alternative embodiment of a test gas generator, which maybe included in the pellistor sensor.

### DETAILED DESCRIPTION OF PREFERRED EMBODIMENTS OF THE INVENTION

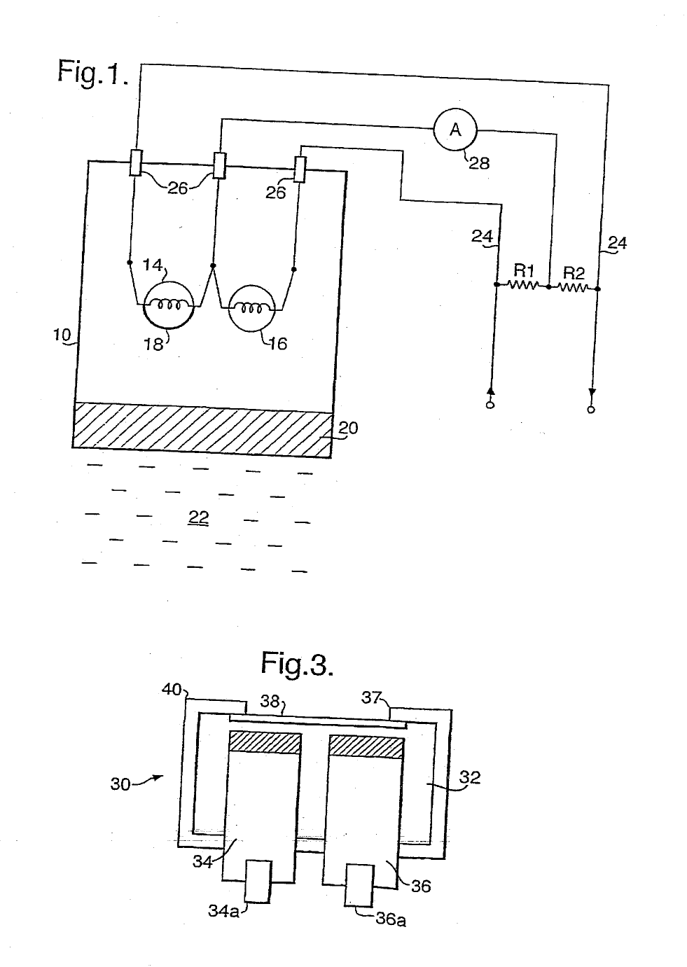

In FIG. 1, a pellistor sensor 10 comprises a housing 12 in which a pair of pellistors 14 and 16 are located. Pellistor 14 is coated with a catalyst such as platinum, palladium, or rhodium 18 and is referred to as the active pellistor. Pellistor 16 is the inactive pellistor (compensator) and is not coated with any catalyst. A sintered metal disc 20 permits the diffusion of gases 22 into the body of housing 12; and also acts as a flame arrester.

Electric current is delivered along wires 24. Electrical contact through the wall of the housing is via conductive pins 26.

Both pellistors 14 and 16 are heated by the electric current and at steady state (i.e. when no flammable gas is present) ammeter 28 reflects this balanced state of the bridge circuit (comprising the two coils and resistors R1 and P2).

The result is that flammable gas 22 is oxidised producing an exothermic reaction that heats the active pellistor 18 and decreases the resistance of the associated wire coil. Ammeter 28 measures the load change as it alters the “balanced” bridge. The amount of change is proportional to the concentration of gas.

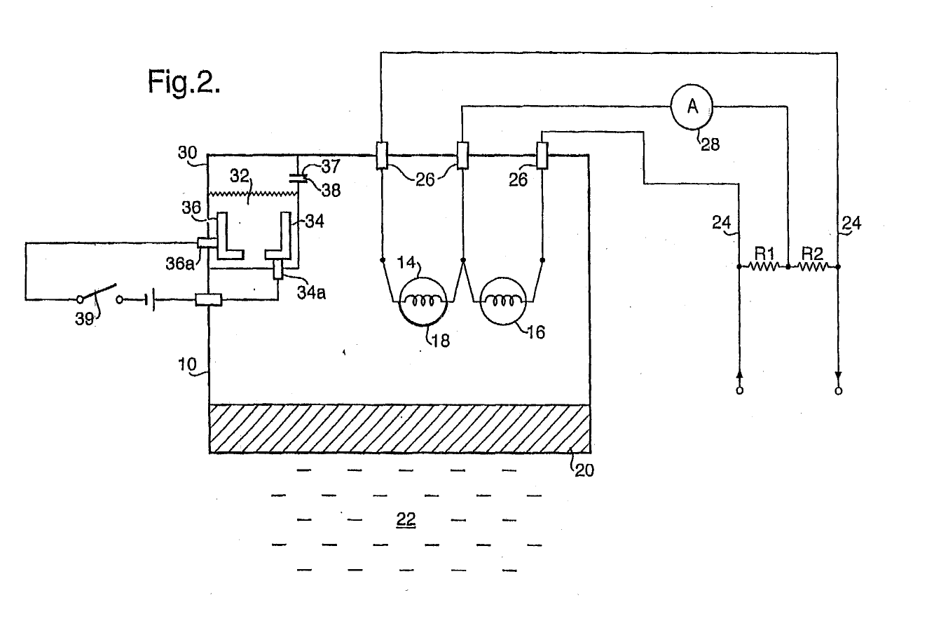

FIG. 2 shows a diagrammatic sectional view through an embodiment of the invention in which like parts bear the same reference numbers. An electrochemical test gas generator 30 is formed integrally with (or may be retrofitted to) the pellistor sensor 10. Test gas generator 30 includes an electrolyte 32, such as sulphuric acid, and two electrodes 34 and 36. Test current is delivered to the test gas generator via contact pins 34a and 36a. Test gas (hydrogen) is vented from the test gas generator 30 via a channel 37. A gas permeable membrane 38, such as a PTFE coated microporous sheet or membrane, seals the test gas generator 30 from the pellistor sensor thereby preventing the electrolyte leaking into the pellistor sensor. Upon depression of switch 39 a small volume of test gas is generated which diffuses from the test gas generator 30 directly into housing 10 and reacts at the surface of pellistor 18 so as to generate an imbalance 25 at ammeter 28. This imbalance may be used to indicate the status of the pellistor sensor.

FIG. 3 shows an alternative embodiment of a test gas generator, which is formed separately from a moulded synthetic plastics material 40, such as, polycarbonate.

Embodiments of the invention have been described by way of example only. Variation may be made to the embodiments described without departing from the scope of invention. For example, and without limitation, means may be provided for indicating which one of several pellistor sensors is faulty or poisoned. This may entail sending an electronic address as a signal on the carriers that provide the electric current for powering the pellistor. Such an arrangement facilitates easy location of the faulty sensor.

What is claimed is:

1. A gas sensor including or consisting of a housing and sensor, the sensor being located in said housing and being adapted to provide a signal indicative of the presence of a gas in said housing, and a test gas generator for supplying a test gas on demand into said housing, thereby enabling the operation of the sensor to be tested, characterized in that the sensor is a pellet resistor sensor.

2. A sensor according to claim 1 wherein the test gas generator includes an electro-chemical cell capable of producing hydrogen.

3. A sensor according to claim 2 wherein the test gas generator comprises a housing containing sulphuric acid and has a gas permeable cover.

4. A sensor according to claim 3 wherein the gas permeable cover comprises a microporous membrane carrying a polytetraflourethene layer.

5. A sensor according to claim 4 wherein electrodes are printed onto the gas permeable cover.

6. A sensor according to claim 2 wherein electrodes include a suitable catalyst for promoting the generation of the test gas is provided.

7. A sensor according to claim 5 wherein electrodes include a suitable catalyst for promoting the generation of the test gas is provided.

8. A sensor according to claim 6 wherein the catalyst is a member of the group consisting of carbon, platinum, ruthenium and rhodium.

9. A sensor according to any claim 1 having electrical contacts, in the form of pins, which connect electrodes (within the housing) to external wires, which lead to a remote current source.

10. A sensor according to claim 9 wherein the pins are in sealing engagement with apertures in the housing through which they protrude.
